(19) United States
(12) Patent Application Publication
(10) Pub. No.: US 2023/0319104 A1
(43) Pub. Date: Oct. 5, 2023

(54) HCI MANAGED ARP

(71) Applicant: Dell Products L.P., Round Rock, TX (US)

(72) Inventors: Baoli CHEN, Shanghai (CN); Bruce Bin HU, Shanghai (CN)

(73) Assignee: Dell Products L.P., Round Rock, TX (US)

(21) Appl. No.: 17/724,313

(22) Filed: Apr. 19, 2022

(30) Foreign Application Priority Data
Apr. 2, 2022 (CN) 202210353614.2

(51) Int. Cl. H04L 9/40

(52) U.S. Cl. CPC H04L 63/1466

(57) ABSTRACT

An information handling system may include at least one processor and a memory. The information handling system may be configured to: maintain a repository of address resolution protocol (ARP) records for a plurality of information handling systems; and in response to a request from one of the plurality of information handling systems to update a record in the repository: validate the request; update the record; and distribute the updated record to at least some of the plurality of information handling systems.

### TECHNICAL FIELD

The present disclosure relates in general to information handling systems, and more particularly to techniques for managing address resolution protocol (ARP) and preventing spoofing.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In the HCI context (as well as other contexts), ARP is a communication protocol that may be used for discovering a link layer address (e.g., a media access control (MAC) address), associated with a given internet layer address (e.g., an IP address). Incorrect ARP records are a threat to network security and stability. In general, they may be caused unwittingly by internet protocol (IP) address conflicts and/or purposely by an attacker (known as ARP spoofing).

In HCI systems, nodes may frequently scale into and out of a cluster, causing a large number of dynamic IP address changes. This can increase the risk of ARP issues.

Accordingly, embodiments of this disclosure may provide techniques for automated avoidance of ARP spoofing, which may leverage a centralized source of truth to provide protection to an entire system or datacenter. The example of an HCI cluster will be discussed in detail for the sake of concreteness, but one of ordinary skill in the art with the benefit of this disclosure will understand its applicability to other systems.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with ARP spoofing may be reduced or eliminated.

In accordance with embodiments of the present disclosure, an information handling system may include at least one processor and a memory. The information handling system may be configured to: maintain a repository of address resolution protocol (ARP) records for a plurality of information handling systems; and in response to a request from one of the plurality of information handling systems to update a record in the repository: validate the request; update the record; and distribute the updated record to at least some of the plurality of information handling systems.

In accordance with these and other embodiments of the present disclosure, a computer-implemented method may include: an information handling system maintaining a repository of address resolution protocol (ARP) records for a plurality of information handling systems; and in response to a request from one of the plurality of information handling systems to update a record in the repository, the information handling system: validating the request; updating the record; and distributing the updated record to at least some of the plurality of information handling systems.

In accordance with these and other embodiments of the present disclosure, an article of manufacture may include a non-transitory, computer-readable medium having computer-executable instructions thereon that are executable by a processor of an information handling system for: maintaining a repository of address resolution protocol (ARP) records for a plurality of information handling systems; and in response to a request from one of the plurality of information handling systems to update a record in the repository: validating the request; updating the record; and distributing the updated record to at least some of the plurality of information handling systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example process flow for a new host joining a cluster, in accordance with embodiments of the present disclosure;

FIG. 3 illustrates an example process flow for a host leaving a cluster, in accordance with embodiments of the present disclosure; and

FIG. 4 illustrates an example process flow for a host replacing or reconfiguring a network interface card, in accordance with embodiments of the present disclosure.

### DETAILED DESCRIPTION

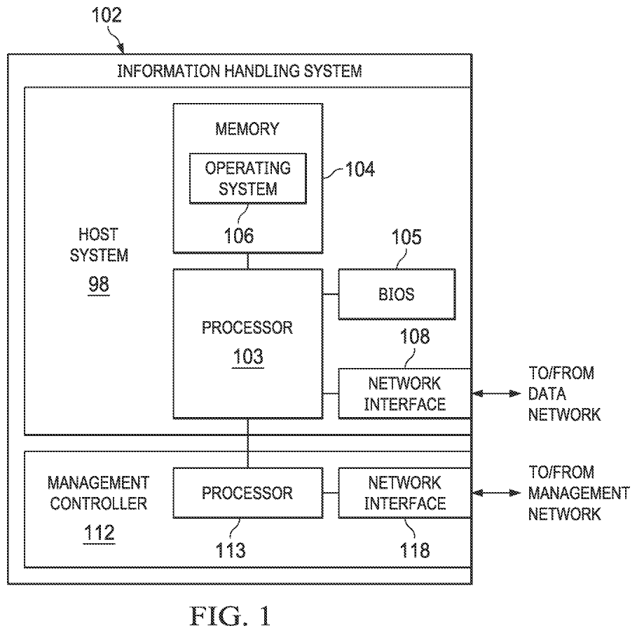

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide protection against incorrect ARP records, such as records resulting from ARP spoofing attacks. One embodiment leverages a central control point as single trusted source of truth. For example, an HCI management system (e.g., a management VM executing a node of a cluster) may be designated as the central control point. In general, the term “central control point” is used herein to denote any system that is reachable by other hosts and is considered a source of truth for ARP data. The central control point may collect valid ARP records and distribute them to all available hosts in that cluster. In some embodiments, the central control point and the other hosts may have a pre-existing trusted and/or encrypted communication channel that allows them to transmit the ARP information in a secure manner.

The hosts in the cluster may use an application programming interface (API) such as a REST API provided by the central control point to register, deregister, and/or update the NIC adapter IP address and media access control (MAC) address information of other hosts, and then create and/or update local static ARP records. As discussed below, this ability may be particularly useful in situations that may arise in the context of HCI clusters. For example, when a new host joins a cluster, an ARP record for the new host needs to be distributed to the rest of the cluster. (And because initialization of a new cluster can be considered as a plurality of new hosts joining, this embodiment is applicable to cluster initialization as well.) When a host leaves a cluster, its ARP record needs to be deleted from the rest of the cluster. When a host replaces or reconfigures its network adapter, an updated ARP record needs to be distributed to the rest of the cluster.

Embodiments may leverage a first component executing at the central control point and a second component executing at each host of a cluster. The first and second components may each be implemented as hardware, software, and/or firmware. For example, in one embodiment, they may be implemented to execute within a VM on the respective hosts.

The central control point component may provide a data collector service, which may collect the layer 3 interface ARP information for all hosts of the cluster (including the information for the central control point itself) and store such information in an ARP repository. This service may allow hosts to register their L3 interface ARP records, and it may also provide an interface for requesting hosts to join the cluster, leave the cluster, or change their ARP information. The central control point component may also provide an ARP bundle data set, which contains the necessary information to record and identify the cluster's host network configuration. This may include information such as a Cluster ID, a Host ID, an L3 interface IP address, a NIC adapter MAC address, a virtual local area network (VLAN) ID in situations using VLANs, etc.

The central control point component may also include a data distributor service. When there is any data change in the data stored by the data collector service, the data distributor service may push the change to each node. For example, updates may be based on snapshots of the data, differential updates, etc.

The host component executing at each host of a cluster may include a host ARP receiver. The host ARP receiver may function as a data receiver, which may provide a REST API service for the central control point to call into to push ARP content for the cluster. The host component may further include a data updater, which may update a local table of ARP entries according to data received from the central control point.

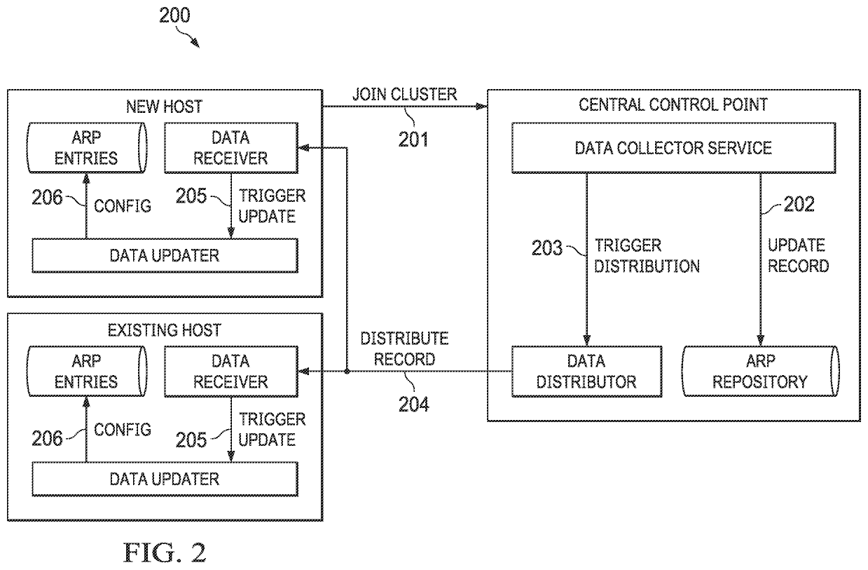

Turning now to FIG. 2, an example method 200 is shown for the ARP management tasks that may occur when a new host joins a cluster. At step 201, the new host may send ARP bundle information to the central control point to trigger the process for adding the new host to the cluster.

At step 202, the central control point may update its records accordingly. If the ARP bundle is valid (e.g., with no conflicts), then the central control point's ARP repository may be updated. If the ARP bundle is not valid, then the central control point may take no further action. It is common in modern hypervisors and operating systems for static ARP entries to take higher priority than dynamic ARP entries. Accordingly, a valid new host registration can happen without causing problems, because there is no static ARP entry for that new IP.

At step 203 (assuming the ARP bundle is valid), the central control point may trigger distribution to each host (including itself). At step 204, the central control point may distribute the records by sending update information to each host.

At step 205, the hosts may trigger an update. After receiving the central control point's distribution from step 204, each host may apply the new data via a data updater component. At step 206, each host may execute a configuration task to apply the changes to its own ARP entries. After step 206, the method may end.

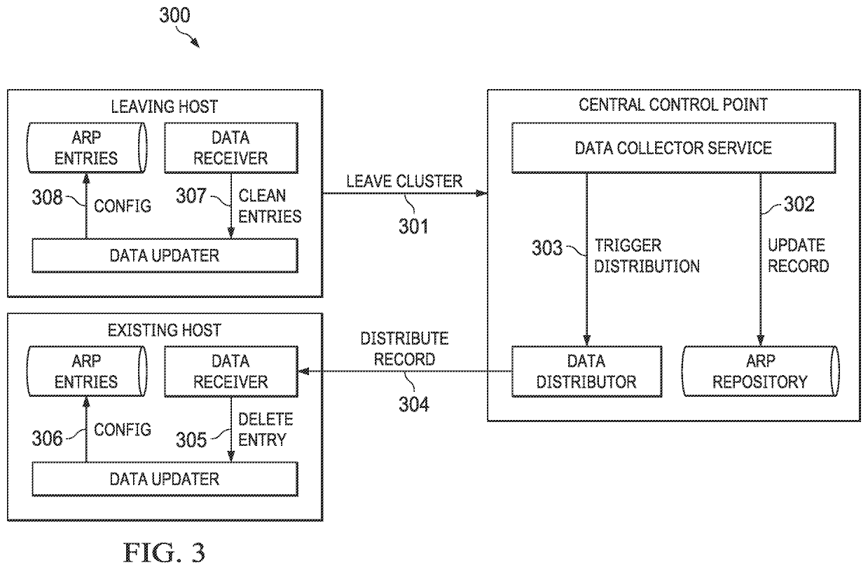

Turning now to FIG. 3, an example method 300 is shown for the ARP management tasks that may occur when a host leaves a cluster. At step 301, the host leaving the cluster may send a request to the central control point to trigger the process for removing a host.

At step 302, the central control point may update its records accordingly. If the request is valid (e.g., an ARP record corresponding to the removal request exists), then the central control point's ARP repository may be updated. If the request is not valid, then the central control point may take no further action. Because static ARP records takes higher precedence than dynamic ARP records, the communication between the central control point to the hosts of the cluster will remain normal.

At step 303 (assuming the request is valid), the central control point may trigger distribution to each host (including itself). At step 304, the central control point may distribute the records by sending update information to each host.

At step 305, the hosts may trigger deletion of the specified ARP entry for the host that is leaving the cluster. At step 306, each host may execute a configuration task to apply the deletion to its own ARP entries.

At step 307, the host leaving the cluster may trigger cleanup of its local ARP entries. At step 308, the host leaving the cluster may execute a configuration task to implement the cleanup of the local ARP table (e.g., by resetting it to a default state). After step 308, the method may end.

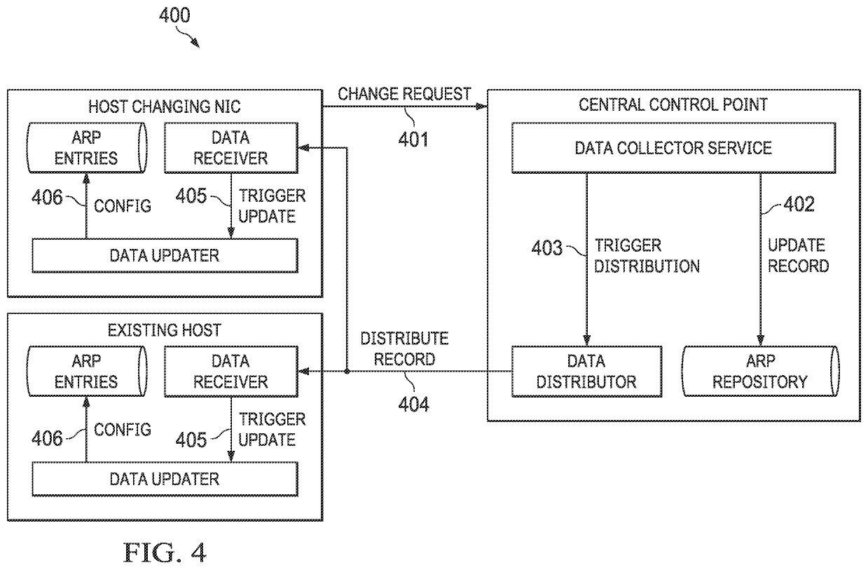

Turning now to FIG. 4, an example method 400 is shown for the ARP management tasks that may occur when a host replaces (or reconfigures) a NIC. At step 401, the host may send a change request (e.g., including an old ARP bundle and a new ARP bundle to replace the old ARP bundle) to the central control point to trigger the process for updating the ARP information.

At step 402, the central control point may update its records accordingly. If the request is valid (e.g., the old ARP bundle exists and the new ARP bundle does not), then the central control point's ARP repository may be updated. If the request is not valid, then the central control point may take no further action. Because static ARP records takes higher precedence than dynamic ARP records, the communication between the central control point to the hosts of the cluster will remain normal.

At step 403 (assuming the request is valid), the central control point may trigger distribution to each host (including itself). At step 404, the central control point may distribute the records by sending update information to each host.

At step 405, the hosts may trigger an update. After receiving the central control point's distribution from step 404, each host may apply the new data via a data updater component. At step 406, each host may execute a configuration task to apply the changes to its own ARP entries. After step 406, the method may end.

One of ordinary skill in the art with the benefit of this disclosure will understand that the preferred initialization point for the methods depicted in FIGS. 2-4 and the order of the steps comprising those methods may depend on the implementation chosen. In these and other embodiments, the methods may be implemented as hardware, firmware, software, applications, functions, libraries, or other instructions. Further, although FIGS. 2-4 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
maintain a repository of address resolution protocol (ARP) records for a plurality of information handling systems; and
in response to a request from one of the plurality of information handling systems to update a record in the repository:
validate the request;
update the record; and
distribute the updated record to at least some of the plurality of information handling systems.

2. The information handling system of claim 1, wherein the plurality of information handling systems are host systems of a hyper-converged infrastructure (HCI) cluster.

3. The information handling system of claim 2, wherein the repository is maintained by a virtual machine executing on a particular one of the host systems.

4. The information handling system of claim 1, wherein the request to update the record comprises a request to create a new record for a particular information handling system that has been added to the plurality of information handling systems.

5. The information handling system of claim 1, wherein the request to update the record comprises a request to delete an existing record for a particular information handling system that has been removed from the plurality of information handling systems.

6. The information handling system of claim 1, wherein the request to update the record comprises a request to alter an existing record for a particular information handling system that has undergone a change relating to a network interface adapter.

7. A computer-implemented method comprising:
an information handling system maintaining a repository of address resolution protocol (ARP) records for a plurality of information handling systems; and
in response to a request from one of the plurality of information handling systems to update a record in the repository, the information handling system:
validating the request;
updating the record; and
distributing the updated record to at least some of the plurality of information handling systems.

8. The method of claim 7, wherein the plurality of information handling systems are host systems of a hyper-converged infrastructure (HCI) cluster.

9. The method of claim 8, wherein the repository is maintained by a virtual machine executing on a particular one of the host systems.

10. The method of claim 7, wherein the request to update the record comprises a request to create a new record for a particular information handling system that has been added to the plurality of information handling systems.

11. The method of claim 7, wherein the request to update the record comprises a request to delete an existing record for a particular information handling system that has been removed from the plurality of information handling systems.

12. The method of claim 7, wherein the request to update the record comprises a request to alter an existing record for a particular information handling system that has undergone a change relating to a network interface adapter.

13. An article of manufacture comprising a non-transitory, computer-readable medium having computer-executable instructions thereon that are executable by a processor of an information handling system for:
maintaining a repository of address resolution protocol (ARP) records for a plurality of information handling systems; and
in response to a request from one of the plurality of information handling systems to update a record in the repository:
validating the request;
updating the record; and
distributing the updated record to at least some of the plurality of information handling systems.

14. The article of claim 13, wherein the plurality of information handling systems are hosts systems of a hyper-converged infrastructure (HCI) cluster.

15. The article of claim 14, wherein the repository is maintained by a virtual machine executing on a particular one of the host systems.

16. The article of claim 13, wherein the request to update the record comprises a request to create a new record for a particular information handling system that has been added to the plurality of information handling systems.

17. The article of claim 13, wherein the request to update the record comprises a request to delete an existing record for a particular information handling system that has been removed from the plurality of information handling systems.

18. The article of claim 13, wherein the request to update the record comprises a request to alter an existing record for a particular information handling system that has undergone a change relating to a network interface adapter.
